(19) United States
(12) Patent Application Publication
(10) Pub. No.: US 2024/0387073 A1
(43) Pub. Date: Nov. 21, 2024

(54) ENAMELED WIRE

(71) Applicants: Johann REICHER, Bad Muender (DE); Roxana HAASE, Bad Pyrmont (DE)

(72) Inventors: Johann REICHER, Bad Muender (DE); Roxana HAASE, Bad Pyrmont (DE)

(21) Appl. No.: 18/641,378

(22) Filed: Apr. 21, 2024

(30) Foreign Application Priority Data
Apr. 27, 2023 (DE) 102023110910.3

(51) Int. Cl. H01B 7/02

(52) U.S. Cl. CPC H01B 7/0225

(57) ABSTRACT

An enameled wire has a conductor core having an outer surface and an electrically insulating laminate completely covering the outer surface. This laminate is formed by an inner base layer directly on the outer surface, at least two separate neutral outer layers surrounding the inner base layer and of a neutral polymer containing no filler affecting discharge resistance, and a functional outer layer surrounding the inner base layer and of a functional polymer including a functional filler increasing discharge resistance of the laminate.

### FIELD OF THE INVENTION

The present invention relates to enameled wire.

### BACKGROUND OF THE INVENTION

Standard enameled wire has a conductor core whose outer surface is completely or substantially completely coated with electrically insulating varnish. The electrically insulating varnish is itself formed by a plurality of layers of which at least one is a base layer of a base varnish polymer preferably applied directly to the conductor core.

Enameled wires of the type described above are generally known in practice in various embodiments. The enameled wires are used in electrical components such as coils, rotors, electric motors, transformers, and the like that in turn are used, for example, in drive technology in the automotive sector or in wind turbines. The enameled wires are usually wound into coils for the necessary components. During operation of the enameled wires or components, partial discharges can occur, for example due to high operating voltages. The partial discharge processes accelerate the ageing process of the electrical insulation varnishes and consequently reduce the service life of the enameled wire, which is undesirable.

In this context, enamel materials that increase the partial-discharge resistance of enameled wires are known in practice. Such enamel materials have generally proven their worth. However, it has been shown that the service life of the enameled wires or the electrical insulation enamels cannot be increased to a satisfactory extent with the known measures. In addition, the material costs of the enamel materials known in practice for increasing the partial-discharge resistance are generally very high, so that the production of enameled wires coated with these materials is correspondingly costly.

An optimal compromise between material or manufacturing costs on the one hand and satisfactory partial-discharge resistance of the electrically insulating laminates on the other hand has not been realized so far. This is where the invention comes in.

### OBJECTS OF THE INVENTION

It is therefore an object of the present invention to provide an improved enameled wire.

Another object is the provision of such an improved enameled wire that overcomes the above-given disadvantages, in particular that is characterized by satisfactory, in particular improved, partial-discharge resistance and that nevertheless meets all requirements in terms of material costs and, in particular, economical manufacture.

### SUMMARY OF THE INVENTION

The enameled wire according to the invention has a conductor core having an outer surface and an electrically insulating laminate completely covering the outer surface. This laminate is formed by
at least two separate neutral outer layers surrounding the inner base layer and of a neutral polymer containing no filler affecting discharge resistance, and
a functional outer layer surrounding the inner base layer and of a functional polymer including a functional filler increasing discharge resistance of the laminate.

In the context of the invention, the term partial discharge refers in particular to a localized electrical discharge that only partially bridges the insulation between conductors. In the context of the invention, partial-discharge resistance means in particular the resistance of an electrically insulating laminate to partial discharge loads and in particular the service life of an enameled wire or electrical insulation varnish under partial discharge load. In the context of the invention, electrically insulating varnish means, in particular, a varnish that is applied to a conductor core and, after curing as an electrically insulating varnish coating, electrically insulates the conductor core. In the context of the invention, conductor core means in particular an electrical wire, preferably a metal wire.

Preferably, there is also an inner base layer of a base lacquer polymer applied directly to the conductor core. The base layer of a base lacquer polymer is a primer characterized in particular by good adhesion to the metallic conductor core. In the context of the invention, base layer means in particular a lacquer layer comprising a base lacquer polymer that is free or essentially free of fillers that increase the partial-discharge resistance. Preferably, the base layer consists of the base lacquer polymer or consists essentially of a base lacquer polymer. In the context of the invention, the fact that according to a preferred embodiment the base layer is applied directly to the conductor core means in particular that the base layer is applied to the conductor core without the interposition of further lacquer layers.

According to the invention, at least two neutral layers of a neutral lacquer polymer and a functional layer of a functional lacquer polymer surround the conductor core, preferably over the base layer. In the context of the invention, neutral layer means in particular a lacquer layer of a neutral lacquer polymer that is free or essentially free of fillers that increase the partial-discharge resistance. Preferably, the neutral layers each consist of the neutral enamel polymer or consist essentially of the neutral enamel polymer. It has proven to be the case that the neutral enamel polymer is a conventional base coat for coating enameled wires.

In the context of the invention, functional layer means, in particular, a lacquer layer comprising a functional lacquer polymer that has a filler for increasing the partial-discharge resistance of the functional layer or of the electrical insulating lacquer. The functional layer thus serves, in particular in combination or interaction with the other lacquer layers of the electrical insulating lacquer, within the scope of the invention to increase the partial-discharge resistance or the service life of the electrical insulating lacquer. Expediently, the functional layer consists of the functional varnish polymer and the filler or consists essentially of the functional varnish polymer and the filler.

The invention recognizes that with a combination of at least two neutral layers and a functional layer that has a filler increasing the partial-discharge resistance of the functional layer or the electrically insulating laminate, and preferably with a base layer, a surprisingly advantageous compromise is achieved between partial-discharge resistance or service life and manufacturing costs of the electrical insulation varnish or the enameled wire. Surprisingly, it is not necessary to provide the conductor core predominantly or completely with functional layers to increase the partial-discharge resistance, but in particular the combination of neutral layers and functional layers leads to both a cost saving within the scope of the invention as well as to very low manufacturing costs. The cost reduction results primarily from the reduction in the number of paint layers or functional layers required that contain fillers to increase the partial-discharge resistance.

A particularly preferred embodiment of the enameled wire according to the invention is characterized in that the electrically insulating laminate has at least two, preferably at least three, preferably at least four, functional layers. It is further preferred that the electrically insulating laminate has at least five, particularly preferably at least six functional layers. According to a further embodiment of the invention, the electrically insulating laminate has a maximum of 50, preferably a maximum of 40, particularly preferably a maximum of 30 functional layers.

According to a recommended embodiment of the invention, the electrically insulating laminate has at least three, preferably at least four, preferably at least five, neutral layers. It is further preferred that the electrically insulating laminate has at least six, particularly preferably at least seven neutral layers. According to a further embodiment of the invention, the electrically insulating laminate has a maximum of 50, preferably a maximum of 40, particularly preferably a maximum of 30 neutral layers.

It has been proven that the electrically insulating laminate has a total of at least five, in particular at least six, preferably at least eight, preferably at least 15, more preferably at least 20, particularly preferably at least 30, very preferably at least 40, particularly preferably at least 50, for example 60 layers of varnish. It is possible for the electrically insulating laminate to have a total of at least 70, preferably at least 80 layers of varnish. It is expedient for the electrically insulating laminate to have a maximum total of 100, preferably a maximum of 90, very preferably a maximum of 80 layers.

Conveniently, the proportion of all functional layers in the total of the lacquer layers of the electrical insulating lacquer is 10% to 75% by weight, preferably 15% to 65% by weight, preferably 20% to 55% by weight, particularly preferably 25% to 50% by weight.

It has proved particularly useful in the context of the invention that at least some of the neutral layers and functional layers of the electrically insulating laminate are form a coating stack in which the neutral layers and the functional layers alternate and the stack has no further varnish layers apart from the neutral layers and functional layers alternating with one another. The fact that the neutral layers and the functional layers alternate means in particular that a functional layer follows a neutral layer in the coating unit, and vice versa, so that, for example, the sequence “neutral layer, functional layer, neutral layer, functional layer . . . ” is provided. It is particularly preferred that the electrically insulating laminate, apart from the preferably provided a base layer, only has the layer stack of neutral layers and functional layers. In this case, the layer stack of neutral layers and functional layers is conveniently arranged directly on the conductor core or directly on the base layer. It is also within the scope of the invention that the electrically insulating laminate has only two base layers, preferably only one base layer.

The embodiment with a layer stack consisting of neutral layers and functional layers, in which the neutral layers and the functional layers alternate, is based on the discovery that the alternating arrangement of neutral layers and functional layers can achieve a particularly optimal compromise between material costs and partial-discharge resistance of the electrically insulating laminate or enameled wire. Compared to many measures known in practice, the alternating arrangement of neutral layers and functional layers in this embodiment can even achieve surprisingly improved partial-discharge resistance and increased service life. The use of neutral layers made of a neutral varnish polymer that is relatively inexpensive, results in excellent cost-effectiveness of the resulting enameled wire or electrical insulation varnish. Nevertheless, the resulting enameled wire meets all requirements for partial-discharge resistance. Due to the layer structure of the electrical insulation varnish according to the invention and in particular due to the preferably provided layer stack of neutral layers and functional layers, the required number of functional layers that have a filler to increase the partial-discharge resistance and/or the required amount of corresponding varnish for the functional layers can be reduced compared to the measures known from practice.

It has been proven that the functional layers and the neutral layers of the coating aggregate are formed from the same coating polymer and in particular from polyamide-imide or polyimide. In principle, however, it is also possible for the neutral layers and the functional layers of the coating unit to be based on different coating polymers and/or for the individual neutral layers and the individual functional layers of the coating unit to be based on different coating polymers.

It is recommended that the layer stack of neutral layers and functional layers has at least two neutral layers, preferably at least three neutral layers and a functional layer, preferably at least two functional layers, preferably at least three functional layers. It is further preferred that the layer stack has at least four neutral layers, very preferably at least five neutral layers, most preferably at least six neutral layers. It is also preferred that the layer stack has at least four functional layers, very preferably at least five functional layers, most preferably at least six functional layers.

A particularly preferred embodiment of the invention is characterized in that a functional layer or a neutral layer is arranged directly on the conductor core or directly on the base layer. It has also proven to be the case that, apart from the preferably provided a base layer, the neutral layers and the functional layers, the electrically insulating laminate has no further varnish layers or layers.

Preferably, the filler of the functional layer is an inorganic material and/or an organic material. A highly preferred embodiment of the invention is characterized in that the filler of the functional layer is a filler selected from the group: “mica, kaolin, corundum, corundum, silicates, aluminum oxides, sulfates, silicon dioxides, titanium dioxide, zinc oxide, barium titanate, fullerenes, graphenes, graphite, tetracyanoquinodimethane, thiophenes, phthalocyanines”.
and is preferably a silicate and/or a silicon dioxide and/or zinc oxide. According to a further preferred embodiment, the filler of the functional layer is tetracyanoquinodimethane.

It is within the scope of the invention that the functional layer or the functional layers contain several different fillers to increase the partial-discharge resistance of the functional layer or the electrically insulating laminate, for example at least two fillers. In such an embodiment, two different fillers can each be used in different functional layers and/or in the same functional layer.

The use of an electro-insulating varnish results in a particularly advantageous partial-discharge resistance of the functional layer or the electrically insulating laminate. When the invention refers to lacquer layers that are free or essentially free of fillers to increase the partial-discharge resistance, this means in particular that the lacquer layers are free or essentially free of these fillers. According to a preferred embodiment of the invention, the filler of the functional layer is present at least partially, preferably completely or substantially completely, in the form of nanoparticles in the functional layer. It is then preferred that the functional coating polymer is modified with the nanoparticles, for example by encapsulation and/or chemical bonding of the nanoparticles.

A highly recommended embodiment that is of particular importance in the context of the invention, is characterized in that the base coating polymer and/or the neutral coating polymer and/or the functional coating polymer is varnish polymer based on at least one component selected from the group: “polyester, polyesterimide, polyesteramideimide, polyurethane, polyamide, polyimide, polyamide-imide”, preferably based on at least one component selected from the group: “polyesterimide, polyesteramideimide, polyimide, polyamide-imide” and particularly preferably based on polyimide and/or polyamide-imide. It is preferred that the preferably provided base layer of the electrically insulating laminate consists or essentially consists of the base varnish polymer. It has also proven to be the case that the neutral layers of the electrically insulating laminate consist or essentially consist of the neutral varnish polymer. Further preferably, the functional layer of the electrically insulating laminate consists of the functional varnish polymer and the filler or consists essentially of the functional varnish polymer and the filler. A particularly preferred embodiment of the invention is characterized in that the neutral varnish polymer and the functional varnish polymer and/or the base varnish polymer are based on the same component or polymer component and are preferably based on polyamide-imide and/or polyimide.

It is recommended that the electrically insulating laminate has an outermost cover layer in the form of a neutral layer of a neutral varnish polymer or in the form of a functional layer of a functional varnish polymer. According to a preferred embodiment of the invention, the outermost cover layer in the form of a neutral layer or in the form of a functional layer is part of the layer stack described above comprising alternately arranged neutral layers and functional layers.

According to a further preferred embodiment of the invention, in addition to a preferably provided layer stack of alternating neutral and functional layers, there is an outermost cover layer in the form of a neutral layer or in the form of a functional layer.

It is within the scope of the invention that the layers of the electrically insulating laminate, in particular the preferably provided base layer, the neutral layers and the functional layer, are applied to the conductor core as solvent-containing liquid varnishes. According to a preferred embodiment, the application as liquid paint can be carried out in paint baths, in particular in dip baths. It is also possible for the liquid lacquers to be applied to the conductor core via a felt or nozzle applicator. The liquid lacquer or the individual lacquer layers are then preferably each cured, particularly preferably by heating. It is preferred that the outer layer of the electrical insulation varnish described above is then also applied to the conductor core as a liquid varnish.

According to an alternative preferred embodiment of the invention, the electrically insulating laminate has an outermost cover layer that is extruded onto the neutral layers and the functional layer or layers and the extruded outermost layer is preferably based on at least one of the group: “fluoroethylene propylene (FEP), ethylene tetrafluoroethylene” and the extruded outer layer is preferably based on at least one of the group: “fluoroethylene propylene (FEP), ethylene-tetrafluoroethylene copolymer (ETFE), perfluoroalkoxy polymer (PFA), modified fluoroalkoxy polymer (MFA), Polyvinylidene fluoride (PVDF), polyether ketones (PEK), in particular Polyetheretherketone (PEEK), polyaryletherketone (PAEK), polyether ketone ketone (PEKK), polysulfones, in particular polysulfone (PSU),

polyphenylene sulfone (PPSU), polyphenylene sulfide (PPS), thermoplastic polyimide (TPI)”. In the embodiment in which the outer layer of the electrical insulation coating is extruded on, it is preferred that the other coating layers of the electrical insulation coating, in particular the preferably provided base layer, the neutral layers and the functional layer, are each applied to the conductor core as a solvent-containing liquid coating.

A preferred embodiment of the enameled wire according to the invention is characterized in that a base layer and/or a neutral layer, preferably the neutral layers, and/or a functional layer, preferably the functional layers, is/are each composed of a plurality of, in particular identically or essentially identically formed sublayers or partial layers and the electrically insulating laminate preferably has a total of 8 to 80, preferably 10 to 70, particularly preferably 12 to 60 sublayers or partial layers. In the context of such an embodiment, an individual varnish layer preferably has at least two, preferably at least three, particularly preferably at least four sublayers or partial layers. Particularly preferably, a single coating layer has a maximum of eight, very particularly preferably a maximum of six, for example a maximum of four sublayers or partial layers. In the context of the invention, the fact that the sublayers or partial layers of a coating layer have an identical or essentially identical structure means in particular that the sublayers or partial layers of a coating layer are formed from the same coating polymer or the same coating layer composition. In the context of an embodiment in which a coating layer is composed of several sublayers or partial layers, this coating layer is expediently built up or applied from a number of identical or essentially identical sublayers or partial layers.

A particularly preferred embodiment of the enameled wire according to the invention is characterized in that the total layer thickness of the electrically insulating laminate is 20 μm to 500 μm, in particular 50 μm to 500 μm, preferably 80 μm to 400 μm, preferably 100 μm to 250 μm and/or in that the layer thickness of the entirety of the preferably provided a base layer, the neutral layers and the functional layer or layers of the electrically insulating laminate is 20 μm to 300 μm, in particular 50 μm to 300 μm, preferably 80 μm to 280 μm and preferably 100 μm to 250 μm, for example 120 μm to 230 μm. of the functional layers of the electrically insulating laminate is 20 μm to 300 μm, in particular 50 μm to 300 μm, preferably 80 μm to 280 μm and preferably 100 μm to 250 μm, for example 120 μm to 230 μm. In the context of the invention, the total layer thickness of the electrically insulating laminate means in particular the total thickness of the electrically insulating laminate, i.e. the extent of the entire electrically insulating laminate transverse to the longitudinal direction of the enameled wire. The total layer thickness of the electrically insulating laminate includes any extruded outer layer of the electrically insulating laminate. Layer thickness of the entirety of the preferably provided a base layer, the neutral layers and the functional layer or functional layers of the electrically insulating laminate means, in the context of the invention, in particular the expansion of the entirety of these layers transversely to the longitudinal direction of the enameled wire, any extruded outer layer of the electrically insulating laminate not being taken into account in the layer thickness (a). If the electrically insulating laminate or the enameled wire does not have an extruded outer layer, the total layer thickness thus preferably corresponds to the layer thickness (a).

Preferably the thickness of a bas layer and/or of a neutral layer and/or of a functional layer is between 1 Φm and 50 μm, preferably between 3 μm and 45 μm, particularly preferably between 6 μm and 42 μm and most preferably between 8 μm and 40 μm. Layer thickness or thickness of a layer in the context of the invention means in particular the dimension of the layer transverse to the longitudinal direction of the enameled wire.

According to a preferred embodiment of the enameled wire according to the invention, a functional layer contains 0.05% to 15% by weight, preferably 0.1% to 10% by weight, preferably 0.2% to 5.0% by weight, particularly preferably 0.3% to 3.0% by weight of the filler. Particularly preferably, the filler is homogeneously or essentially homogeneously distributed in the respective functional layer. In this context, the proportion of filler in the functional layer refers in particular to the cured electrically insulating laminate.

Conveniently, the neutral layers of the electrically insulating laminate are each formed from the same neutral varnish polymer. According to an alternative embodiment of the invention, the neutral varnish polymer of a neutral layer, preferably of at least two neutral layers, differs from the neutral varnish polymer of the other neutral layers.

It has been proven that the neutral layers and/or the functional layer or the functional layers and/or the base layer of the electrically insulating laminate are formed from the same varnish polymer and, in particular, are formed from polyimide and/or from polyamide-imide. A particularly preferred embodiment of the invention is characterized in that all lacquer layers of the electrical insulating lacquer are formed from the same lacquer polymer and in particular from polyimide and/or from polyamide-imide.

It is preferred that the conductor core is made of copper and/or aluminum or essentially of copper and/or aluminum. In principle, however, other electrically conductive materials, preferably metals, are also possible materials for the conductor core of the enameled wire.

Conveniently, the conductor core is a flat wire and/or a round wire. In the context of the invention, round wire means in particular a conductor core with a round cross-sectional area. In the context of the invention, flat wire means in particular a conductor core with an oval cross-sectional area. According to a further embodiment of the invention, the conductor core is a rectangular wire with a rectangular cross-sectional area. In principle, other shapes of the cross-sectional area of the conductor core are also within the scope of the invention.

A preferred embodiment of the invention is characterized in that the conductor core has a diameter of 0.03 mm to 20 mm, in particular of 0.04 mm to 10 mm, preferably of 0.04 mm to 8 mm, preferably of 0.05 mm to 7 mm, particularly preferably of 0.1 mm to 6.5 mm. Diameter of the conductor core in this context means the largest diameter of the cross-sectional area of the conductor core transverse to the longitudinal direction of the enameled wire. It is highly preferred that the ratio of the diameter of the conductor core to the total layer thickness of the electrical insulation varnish and/or to the layer thickness is greater than or equal to 3, preferably greater than or equal to 4, preferably greater than or equal to 5, particularly preferably greater than or equal to 10. According to one embodiment, the ratio of the diameter of the conductor core to the total layer thickness of the electrically insulating laminate and/or to the layer thickness is greater than or equal to 15, preferably greater than or equal to 20, particularly preferably greater than or equal to 30, especially preferably greater than or equal to 40.

The invention is explained in more detail below with reference to two embodiments in which the enameled wire according to the invention has the following sequence of layers (from the inside to the outside): Conductor core made of copper and/or aluminum/preferably base layer made of polyamide-imide/neutral layer made of polyamide-imide/neutral layer made of polyamide-imide/functional layer made of polyamide-imide with a filler to increase the partial-discharge resistance/neutral layer made of polyamide-imide/functional layer made of polyamide-imide with a filler to increase the partial-discharge resistance/neutral layer made of polyamide-imide (outer layer).

According to a further highly preferred embodiment, the enameled wire according to the invention has the following layer sequence (from the inside to the outside): Conductor core of copper and/or aluminum/preferably base layer of polyamide-imide/neutral layer of polyamide-imide/neutral layer of polyamide-imide/functional layer of polyamide-imide with a filler to increase the partial-discharge resistance/neutral layer of polyimide/functional layer of polyamide-imide with a filler to increase the partial-discharge resistance/neutral layer of polyimide (outer layer).

According to a particularly preferred embodiment of the invention, the enameled wire according to the invention has the following layer sequence (from the inside to the outside): Conductor core of copper and/or aluminum/preferably base layer of polyamide-imide/preferably neutral layer of polyamide-imide/functional layer of polyamide-imide with a filler to increase the partial-discharge resistance/neutral layer made of polyamide-imide/functional layer made of polyamide-imide with a filler to increase the partial-discharge resistance/neutral layer made of polyamide-imide/functional layer made of polyamide-imide with a filler to increase the partial-discharge resistance/neutral layer made of polyamide-imide (outer layer).

A further recommended embodiment of the invention is characterized by the following layer sequence (from the inside to the outside): Conductor core made of copper and/or aluminum/preferably base layer made of polyamide-imide/neutral layer made of polyimide/preferably neutral layer made of polyimide/functional layer made of polyimide with a filler to increase the partial-discharge resistance/neutral layer made of polyimide/functional layer made of polyimide with a filler to increase the partial-discharge resistance/neutral layer made of polyimide (outer layer).

In the embodiments described above, the coating layers are each formed from the listed coating polymer. Preferably, the individual lacquer layers consist of the listed lacquer polymer or essentially of the listed lacquer polymer and optionally of the listed lacquer polymer and the filler.

The invention is based on the discovery that the enameled wire according to the invention is characterized by a very satisfactory partial-discharge resistance or service life and at the same time by low or at least reduced manufacturing costs compared to known measures. The invention has recognized that in order to achieve a satisfactory and even partially improved partial-discharge resistance, it is not necessary to form the electrically insulating laminate predominantly or completely from varnish layers with fillers that increase the partial-discharge resistance, but that the use of neutral layers on the one hand and functional layers with a filler increasing the partial-discharge resistance on the other hand leads to particular advantages. This concerns on the one hand the reduced amount of corresponding coating polymer with filler for the functional layers and on the other hand the partial-discharge resistance that is nevertheless guaranteed. The invention has recognized that the partial-discharge resistance or the service life of enameled wires coated with electrically insulating laminates according to the invention is even higher, in particular considerably higher, than the service life of enameled wires that are coated exclusively or predominantly with special partial discharge-resistant varnishes or exclusively or predominantly with corresponding functional layers. Thus, not only can an optimum compromise between partial-discharge resistance and manufacturing costs be realized according to the invention, but the structure of the electrical insulation varnish according to the invention even makes it possible to improve the partial-discharge resistance while at the same time keeping manufacturing costs low or at least reducing them. These are considerable advantages compared to the measures known in practice.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1A is a section taken in the region of the dot-dash box IA in FIG. 1B;

FIG. 1B is a cross section of a first embodiment if an enameled wire according to the invention;

FIG. 2A is a section taken in the region of the dot-dash box IIA in FIG. 2B; and

FIG. 2B is a cross section of a second embodiment of the invention.

### SPECIFIC DESCRIPTION OF THE INVENTION

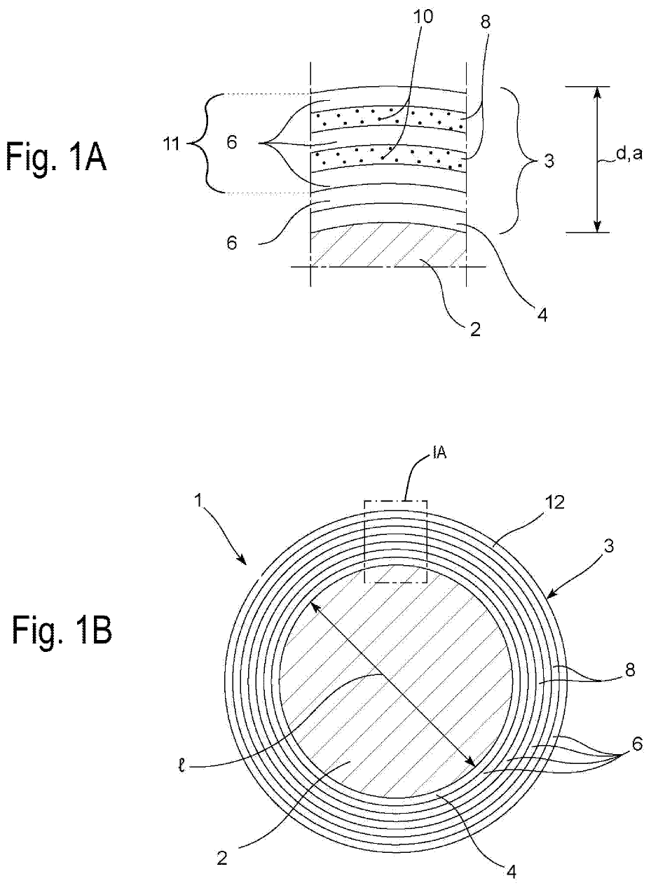

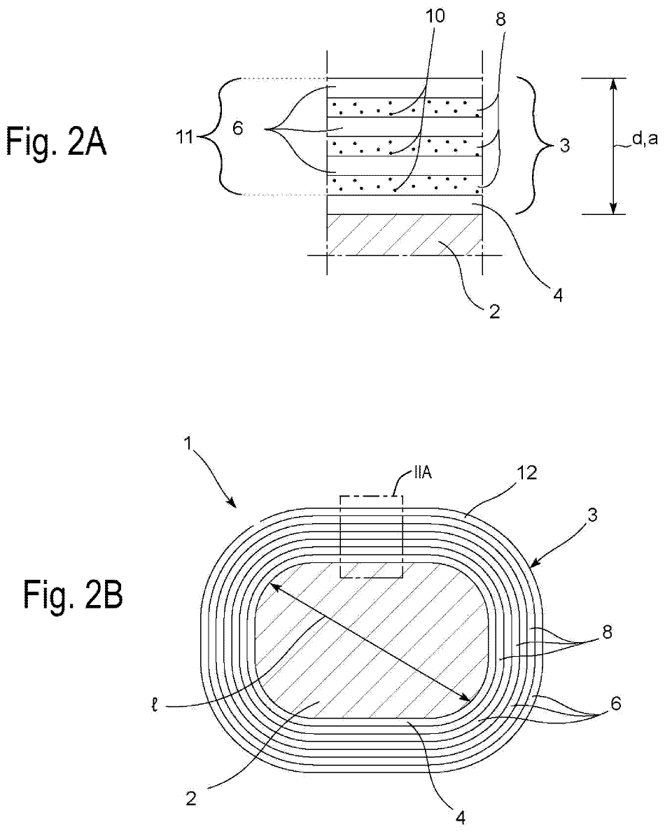

As seen in FIGS. 1A and 1B, an enameled wire 1 has a conductor core 2 preferably and here consisting or essentially consisting of copper. In this embodiment 1, the conductor core 2 is a round solid wire. In the embodiment of FIGS. 2A and 2B the enameled wire 1 has a flatter and nonround conductor core 2.

In accordance with the invention and here, the outer surface of the conductor core 2 is completely coated with an electrically insulating laminate 3 that has a plurality of layers of varnish. A base layer 4 of a base lacquer polymer 6 is applied directly to the conductor core 2 according to the figures. Conveniently and here, the base coating polymer layer 6 is formed from polyamide-imide and, particularly preferably and in the embodiments according to FIGS. 1 and 2, the base layer 4 consists of polyamide-imide. The base layer 4 thus expediently and here according to the figures does not have a filler to increase the partial-discharge resistance of the electrically insulating laminate 3.

In the embodiment shown in FIGS. 1A and 1B, four neutral layers 6 made of a neutral coating polymer and two functional layers 8 made of a functional coating polymer surround the base layer 4. According to a preferred embodiment, the neutral coating polymer layer 6 is based on polyamide-imide and, most preferably and in the embodiment according to FIG. 1, the neutral layers 6 consist of polyamide-imide. In particular, the neutral layers 6 therefore have no filler that would increase the partial-discharge resistance of the electrically insulating laminate 3.

According to a further preferred embodiment, the functional varnish polymer layer 8 is based on polyamide-imide. According to the invention, the functional layers 8 have a filler 10 that increases the partial-discharge resistance of the functional layers 8 of the electrically insulating laminate 3. Preferably and in the embodiment according to FIG. 1A and 1B, the functional layers 8 consist of polyamide-imide and the filler 10. In FIGS. 1A and 1B, the filler 10 of the functional layers 8 may in particular be silicon dioxide. Preferably and here as shown in FIGS. 1A and 1B, a neutral layer 6 is directly on the base layer 4. According to FIGS. 1A and 1B, the enameled wire 1 or the electrically insulating laminate 3 has a layer stack 11 arranged on this neutral layer 6 and comprising three neutral layers 6 and the two functional layers 8, these layers alternate in the layer stack 11, and the layer stack 11 preferably and in the embodiment according to FIG. 1 has no further varnish layers apart from the neutral layers 6 and functional layers 8 arranged in an alternating layer sequence.

Conveniently and according to FIGS. 1A and 1B, a neutral layer 6 is provided as the outermost surface layer 12 of the electrically insulating laminate 3. Further preferably and in the embodiment according to FIGS. 1A and 1B, the neutral layers 6 and the functional layers 8 and the base layer 4 of the electrically insulating laminate 3 are formed from the same varnish polymer, preferably and according to FIG. 1 from polyamide-imide.

Preferably, and in the embodiment shown in FIGS. 2A and 2B, the electrically insulating laminate has in addition to the base layer 4 three layers of polyamide-imide, three neutral layers 6 made from a neutral coating polymer and three functional layers 8 of a functional coating polymer. The neutral coating polymer layers 6 are each preferably based on polyamide-imide and, expediently and in the embodiment according to FIG. 2, the neutral layers 6 consist of polyamide-imide. In particular, the neutral layers 6 therefore do not have a filler increasing the partial-discharge resistance of the electrically insulating laminate 3. The functional varnish polymer layer 8 is preferably based on polyamide-imide and the functional layers 8 each have a filler 10 that increases the partial-discharge resistance of the functional layers 8 or the electrically insulating laminate 3.

In the embodiment shown in FIGS. 2A and 2B, the filler 10 may be silicon dioxide. Thus the functional layers 8 consist of polyamide-imide and the filler 10. In FIGS. 2A and 2B, the three neutral layers 6 and the three functional layers 8 of the electrically insulating laminate 3 are arranged in a layer stack 11, the neutral layers 6 and the functional layers 8 alternate in the layer stack 11, and the layer stack 11 preferably has no further varnish layers apart from the neutral layers 6 and functional layers 8 arranged in alternating layer sequence. Particularly preferably, the electrically insulating laminate 3 has only the layer stack 11 apart from the base layer 4 (FIGS. 2A and 2B). A functional layer 8 lies directly on the base layer 4. Furthermore, preferably and according to FIG. 2, a neutral layer 6 of the outermost one neutral varnish polymer layer 6 forms an outer layer 12 of the electrically insulating laminate 3 that closes to the outside.

Preferably and according to FIGS. 2A and 2B, the neutral layers 6 and the functional layers 8 and the base layer 4 of the electrically insulating laminate 3 are formed from the same varnish polymer and in particular are formed from polyamide-imide, the neutral layers 6 and the base layer 4 particularly preferably consist or consist essentially of polyamide-imide, and the functional layers 8 consist or consist essentially of polyamide-imide and the filler 10.

According to a preferred embodiment of the invention, the total layer thickness d of the electrically insulating laminate 3 is 20 μm to 400 μm, very preferably 100 μm to 250 μm. Here according to the figures, the total layer thickness d of the electrically insulating laminate 3 may be about 200 μm. Here, the lacquer layers of the electrical insulating lacquer 3 are preferably each applied to the conductor core 2 as solvent-based liquid lacquers and cured. A neutral layer 6 conveniently forms the outer layer 12 of the electrically insulating laminate 3. Thus, the total layer thickness d of the electrically insulating laminate 3 preferably corresponds to the layer thickness a of the laminate 3 formed by the base layer 4, the neutral layers 6 and the functional layers 8.

Conveniently and here according to the invention, the neutral layers 6 of the electrically insulating laminate 3 are each formed from the same neutral varnish polymer. Preferably, moreover, one functional layer 8 includes the filler 10 at 0.1 wt. % to 10 wt. %, particularly preferably 0.2 wt. % to 5 wt. % and the filler 10 is particularly preferably homogeneously or substantially homogeneously distributed in the functional layer 8. Here, the functional layers 8 may each contain about 2% by weight of the filler 10.

According to a very preferred embodiment of the invention, the ratio of the diameter 1 of the conductor core 2 to the total layer thickness d of the electrically insulating laminate 3 and/or to the layer thickness a is greater than or equal to 3, particularly preferably greater than or equal to 4, for example greater than or equal to 10. Here according to the figures, the ratio 1/a and the ratio 1/d may be approximately 4.

1. An enameled wire comprising:
a conductor core having an outer surface;
an electrically insulating laminate completely covering the outer surface and formed by
at least two separate neutral outer layers surrounding the conductor core and of a neutral polymer containing no functional filler affecting partial-discharge resistance, and
a functional outer layer surrounding the conductor core and of a functional polymer including a functional filler increasing partial-discharge resistance of the laminate.

2. The enameled wire according to claim 1 wherein the functional outer layer is between the neutral outer layers.

3. The enameled wire according to claim 1, wherein the electrical insulating laminate includes at least two such functional layers.

4. The enameled wire according to claim 1, wherein the electrically insulating laminate includes at least three such neutral layers.

5. The enameled wire according to claim 1, wherein there are at least two of the outer functional layers and two of the outer neutral layers, each neutral outer layer being directly between two of the outer functional layers.

6. The enameled wire according to claim 1, further comprising:
an inner base layer directly on the outer surface.

7. The enameled wire according to claim 6, wherein one of the functional layers or one of the neutral layers lies directly on the inner base layer.

8. The enameled wire according to claim 1, wherein the filler of the functional layer is mica, kaolin, corundum, precious corundum, silicates, aluminum oxides, sulfates, silicon dioxides, titanium dioxide, zinc oxide, barium titanate, fullerenes, graphenes, graphite, tetracyanoquinodimethane, thiophenes, phthalocyanines.

9. The enameled wire according to claim 1, wherein the base enamel layer and/or the neutral enamel layer and/or the functional enamel layer is formed of polyester, polyesterimide, polyesteramideimide, polyurethane, polyamide, polyimide, and/or polyamide-imide.

10. The enameled wire according to claim 1, wherein at least one of the outer layers is outermost on the conductor.

11. The enameled wire according to claim 1, wherein the laminate includes an extruded outermost outer layer of fluoroethylene propylene, ethylene-tetrafluoroethylene copolymer, perfluoroalkoxy polymer, modified fluoroalkoxy polymer, polyvinylidene fluoride, polyether ketones, polyether ether ketone, polyaryletherketone, polyetherketoneketone, polyphenylene sulfone, polyphenylene sulfide, polysulfone, and/or thermoplastic polyimide.

12. The enameled wire according to claim 1, wherein at least the base, neutral, and/or functional layer is formed of 8 to 80 sublayers or partial layers.

13. The enameled wire according to claim 1, wherein a total thickness of the laminate is 20 μm to 500 μm.

14. The enameled wire according to claim 1, wherein the functional layer contains 0.05% to 15% by weight of the filler.

15. The enameled wire according to claim 1, wherein the neutral layers are all formed from the same neutral varnish polymer.

16. The enameled wire according to claim 1, wherein the neutral layers are formed of different varnish polymers.

17. The enameled wire according to claim 1, wherein the conductor core consists of copper and/or aluminum or essentially of copper and/or aluminum.

18. The enameled wire according to claim 1, wherein the conductor core is a flat or a round wire.
